(19) United States
(12) Patent Application Publication
(10) Pub. No.: US 2010/0220255 A1
(43) Pub. Date: Sep. 2, 2010

(54) ARRAY SUBSTRATE FOR FRINGE FIELD SWITCHING MODE LIQUID CRYSTAL DISPLAY DEVICE

(76) Inventors: In-Duk Song, Gumi-Si (KR); Sung-Il Park, Daegu (KR); Se-Eung Lee, Seoul (KR)

Correspondence Address: BIRCH STEWART KOLASCH & BIRCH, PO BOX 747, FALLS CHURCH, VA, 22040-0747, US

(21) Appl. No.: 12/714,327

(22) Filed: Feb. 26, 2010

(30) Foreign Application Priority Data
Mar. 2, 2009 (KR) 10-2009-0017601

(51) Int. Cl. G02F 1/1343; G02F 1/1368

(52) U.S. Cl. 349/46; 349/139

(57) ABSTRACT

An array substrate for a fringe field switching mode liquid crystal display device includes: a substrate; a gate line on the substrate; a gate insulating layer on the gate line; a data line on the gate insulating layer, the data line crossing the gate line to define a pixel region; a thin film transistor connected to the gate line and the data line; a pixel electrode in the pixel region, the pixel electrode having a plate shape and connected to the thin film transistor; a first passivation layer on the pixel electrode; and a common electrode including a plurality of open portions on the first passivation layer, each of the plurality of open portions having a bar shape including a bent part.

This application claims the benefit of Korean Patent Application No. 10-2009-0017601, filed on Mar. 2, 2009, which is hereby incorporated by reference in its entirety.

### BACKGROUND OF THE INVENTION

1. Field of the Invention

The present invention relates to a liquid crystal display (LCD) device, and more particularly, to an array substrate for a fringe field switching (FFS) mode liquid crystal display device.

2. Discussion of the Related Art

In general, the LCD device uses the optical anisotropy and polarization properties of liquid crystal molecules to produce an image. Due to the optical anisotropy of the liquid crystal molecules, refraction of light incident onto the liquid crystal molecules depends upon the alignment direction of the liquid crystal molecules. The liquid crystal molecules have long thin shapes that can be aligned along specific directions. The alignment direction of the liquid crystal molecules can be controlled by applying an electric field. Accordingly, the alignment of the liquid crystal molecules changes in accordance with the direction of the applied electric field and the light is refracted along the alignment direction of the liquid crystal molecules due to the optical anisotropy, thereby images displayed.

Among various types LCD devices, an active matrix type liquid crystal display (AM-LCD) device has been the subject of recent research due to its high resolution and superior quality for displaying moving images.

The LCD device includes a color filter substrate having a common electrode, an array substrate having a pixel electrode, and a liquid crystal layer interposed between the color filter substrate and the array substrate. In the LCD device, the liquid crystal layer is driven by a vertical electric field between the pixel electrode and the common electrode. Although the LCD device provides a superior transmittance and a high aperture ratio, the LCD device has a narrow viewing angle because it is driven by the vertical electric field. Accordingly, various other types of LCD devices having wide viewing angles, such as in-plane switching (IPS) mode LCD device, have been developed.

FIG. 1 is a cross-sectional view of an IPS mode LCD device according to the related art. In FIG. 1, an upper substrate 9 and a lower substrate 10 face and are spaced apart from each other. A liquid crystal layer 11 is interposed between the upper and the lower substrates 9 and 10. The upper substrate 9 and the lower substrate 10 may be referred to as a color filter substrate and an array substrate, respectively. A common electrode 17 and a pixel electrode 30 are formed on the lower substrate 10. The liquid crystal layer 11 is driven by a horizontal electric field “L” between the common electrode 17 and the pixel electrode 30.

FIGS. 2A and 2B are cross-sectional views showing ON and OFF states, respectively, of an IPS mode LCD device according to the related art. In FIG. 2A, voltages are applied to a pixel electrode 30 and a common electrode 17 to generate an electric field “L” having horizontal and vertical components. First liquid crystal molecules 11a of the liquid crystal layer 11 over the pixel electrode 30 and the common electrode 17 are not re-aligned by the vertical component of electric field “L,” and a phase transition of the liquid crystal layer 11 does not occur. Second liquid crystal molecules 11b of the liquid crystal layer 11 between the pixel electrode 30 and the common electrode 17 are re-aligned by the horizontal component of electric field “L,” and a phase transition of the liquid crystal layer 11 occurs. Because the liquid crystal molecules are re-aligned by the horizontal component of the electric field “L,” the IPS mode LCD device has a wide viewing angle. For example, users can see images having a viewing angle of about 80° to about 85° along top, bottom, right and left directions with respect to a normal direction of the IPS mode LCD device.

In FIG. 2B, an electric field having a horizontal component is not generated when voltages are not applied to the IPS mode LCD device. Thus, first and second liquid crystal molecules 11a and 11b are not re-aligned, and a phase transition of the liquid crystal layer 11 does not occur.

Although the IPS mode LCD device has advantages in a viewing angle, the IPS mode LCD device has disadvantages in an aperture ratio and a transmittance. For the purpose of improve improving the disadvantages of the IPS mode LCD device, a fringe field switching (FFS) mode LCD device where liquid crystal molecules are driven by a fringe field has been suggested.

FIG. 3 is a plan view showing an array substrate for an FFS mode LCD device according to the related art. In FIG. 3, a plurality of gate lines 43 and a plurality of data lines 51 are formed over a substrate 41. The plurality of gate lines 43 cross the plurality of data lines 51 to define a plurality of pixel regions P. A thin film transistor (TFT) Tr as a switching element connected to the gate line 43 and the data line 51 is formed in each pixel region P. The TFT Tr includes a gate electrode 45, a gate insulating layer (not shown), a semiconductor layer (not shown), a source electrode 55 and a drain electrode 58. In addition, a passivation layer (not shown) is formed on the TFT Tr, and a pixel electrode 60 is formed on the passivation layer in each pixel region P. The pixel electrode 60 has a plate shape including a plurality of open portions op and is connected to the drain electrode 58 through a contact hole 59 in the passivation layer. Each open portion op has a bar shape. Further, a common electrode 75 having a plate shape is formed over the substrate 41 to overlap the pixel electrode 60.

In the FFS mode LCD device of FIG. 3, when voltages are applied to the pixel electrode 60 including the plurality of open portions op and the common electrode 75, a fringe field is generated in each pixel region P and a liquid crystal layer (not shown) is driven by the fringe field. However, since each pixel region P has a single domain, deterioration in display quality such as a color shift occurs at azimuthal angles of about 0°, about 90°, about 180° and about 270°.

### SUMMARY OF THE INVENTION

Accordingly, the present invention is directed to an array substrate for a fringe field switching mode liquid crystal display device that substantially obviates one or more of the problems due to limitations and disadvantages of the related art.

An advantage of the present invention is to provide an array substrate for a fringe field switching mode liquid crystal display device where a color shift is prevented and a display quality is improved.

Additional features and advantages of the invention will be set forth in the description which follows, and in part will be apparent from the description, or may be learned by practice of the invention. These and other advantages of the invention will be realized and attained by the structure particularly pointed out in the written description and claims hereof as well as the appended drawings.

To achieve these and other advantages and in accordance with the purpose of the present invention, as embodied and broadly described, an array substrate for a fringe field switching mode liquid crystal display device includes: a substrate; a gate line on the substrate; a gate insulating layer on the gate line; a data line on the gate insulating layer, the data line crossing the gate line to define a pixel region; a thin film transistor connected to the gate line and the data line; a pixel electrode in the pixel region, the pixel electrode having a plate shape and connected to the thin film transistor; a first passivation layer on the pixel electrode; and a common electrode including a plurality of open portions on the first passivation layer, each of the plurality of open portions having a bar shape including a bent part.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a cross-sectional view of an IPS mode LCD device according to the related art;

FIGS. 2A and 2B are cross-sectional views showing ON and OFF states, respectively, of an IPS mode LCD device according to the related art;

FIG. 3 is a plan view showing an array substrate for an FFS mode LCD device according to the related art;

FIG. 4 is a plane view showing an array substrate for a fringe field switching mode liquid crystal display device according to a first embodiment of the present invention;

FIG. 5 is a plan view showing an array substrate for a fringe field switching mode liquid crystal display device according to a second embodiment of the present invention;

FIG. 6 is a cross-sectional view taken along a line VI-VI of FIG. 4;

FIG. 7 is a cross-sectional view taken along a line VII-VII of FIG. 4;

FIG. 8 is a plane view showing an array substrate for a fringe field switching mode liquid crystal display device according to a third embodiment of the present invention; and

FIG. 9 is a plan view showing an array substrate for a fringe field switching mode liquid crystal display device according to a fourth embodiment of the present invention.

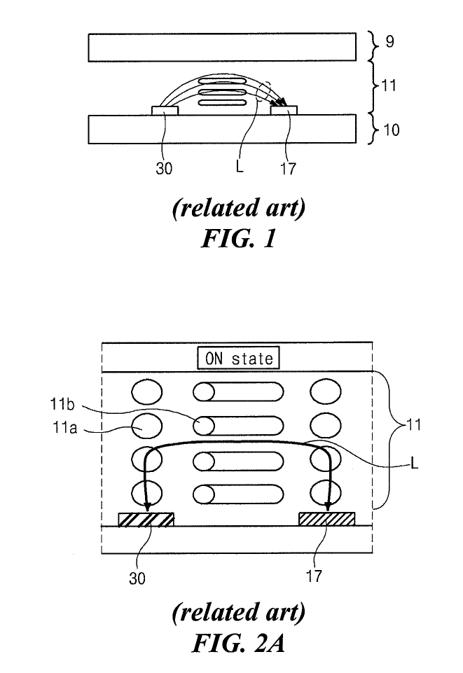

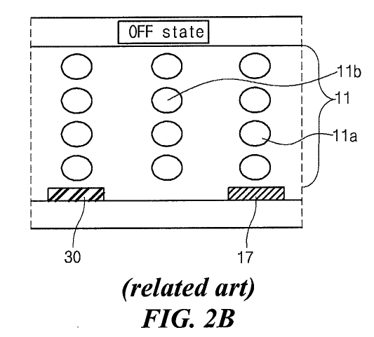

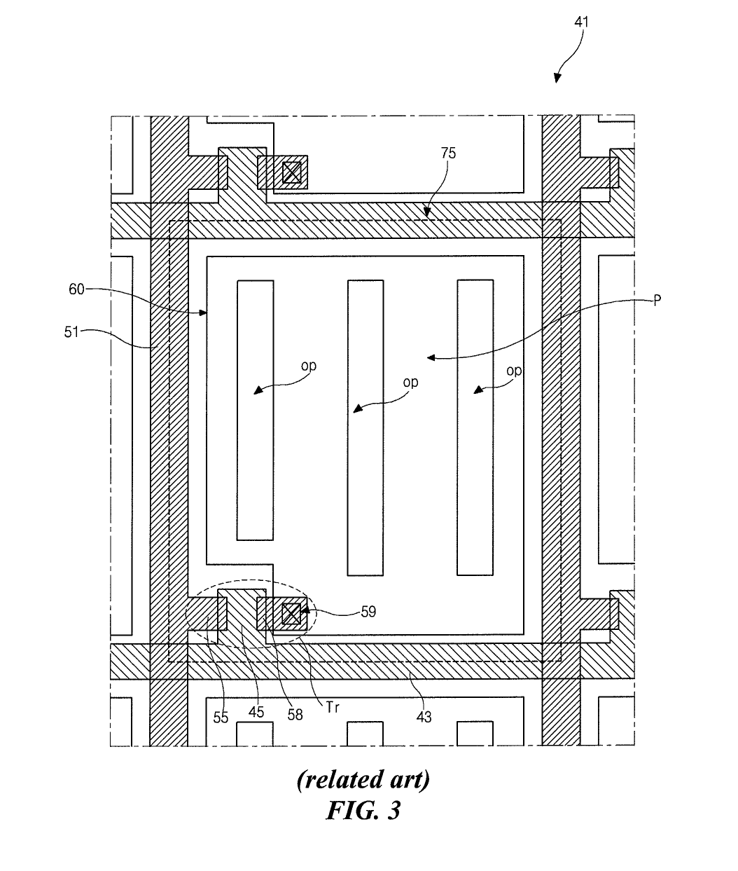

### DETAILED DESCRIPTION OF THE ILLUSTRATED EMBODIMENTS

Reference will now be made in detail to embodiments of the present invention, examples of which are illustrated in the accompanying drawings. Wherever possible, similar reference numbers will be used to refer to the same or similar parts.

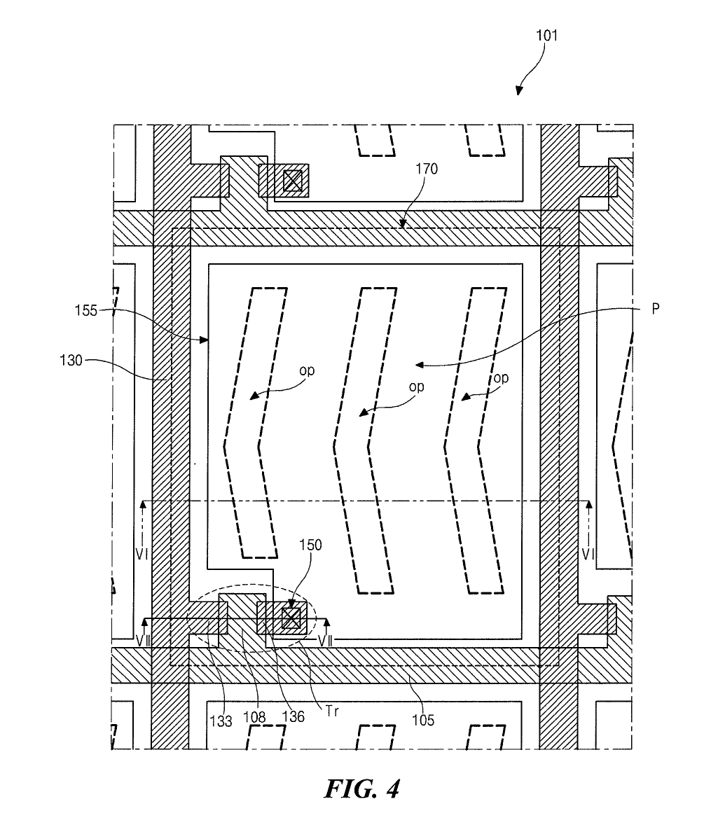

FIG. 4 is a plane view showing an array substrate for a fringe field switching mode liquid crystal display device according to a first embodiment of the present invention.

In FIG. 4, a plurality of gate lines 105 and a plurality of data lines 130 are formed over a substrate 101. The plurality of gate lines 105 cross the plurality of data lines 130 to define a plurality of pixel regions P. Each of the plurality of data lines has a straight line shape. A thin film transistor (TFT) Tr as a switching element connected to the corresponding gate line 105 and the corresponding data line 130 is formed in each pixel region P. The TFT Tr includes a gate electrode 108 connected to the gate line 105, a gate insulating layer (not shown) on the gate electrode 108, a semiconductor layer (not shown) on the gate insulating layer, a source electrode 133 connected to the data line 130 and a drain electrode 136 spaced apart from the source electrode 133. Although not shown in FIG. 4, the semiconductor layer includes an active layer of intrinsic amorphous silicon on the gate insulating layer and an ohmic contact layer of impurity-doped amorphous silicon on the active layer.

The source and drain electrodes 133 and 136 spaced apart from each other expose the active layer of the semiconductor layer, and the exposed portion of the active layer between the source and drain electrodes 133 and 136 is defined as a channel region. Although the TFT Tr of FIG. 4 has the channel region of a linear shape, a TFT may have a channel region of a “U” shape in another embodiment where one of source and drain electrodes has a “U” shape and the other of the source and drain electrodes has a bar shape. In addition, although the TFT Tr of FIG. 4 is disposed in the pixel region P, the semiconductor layer, the gate line 105 may function as a gate electrode the source electrode 133 and the drain electrode 136 may be disposed to overlap the gate line 105 in another embodiment.

A first passivation layer (not shown) is formed on the TFT Tr, and a pixel electrode 155 having a plate shape is formed on the first passivation layer in each pixel region P. The first passivation layer includes a drain contact hole 150 exposing the drain electrode 136 and the pixel electrode 155 is connected to the drain electrode 136 through the contact hole 150. Further, a second passivation layer (not shown) is formed on the pixel electrode 155, and a common electrode 170 is formed on the second passivation layer. Although the common electrode 170 is formed over an entire surface of the substrate 101, a portion of the common electrode 170 corresponding to the pixel region P is shown in FIG. 4 for illustration. The common electrode 170 has a plate shape including a plurality of open portions op. The plurality of open portions op are disposed to correspond to the pixel electrode 155 in the pixel region P, and each of the plurality of open portions op has a bar shape including a bent part. For example, the bent part may be disposed at a central portion of the pixel region and each of the plurality of open portions op may have a symmetric structure with respect to a virtual line connecting the bent parts and parallel to the gate line 105.

Each of the plurality of open portions op includes upper and lower parts with respect to the bent part, and the upper and lower parts are disposed along different directions. As a result, an upper fringe field generated by the upper part of each of the plurality of open portions op has a different direction from a lower fringe field generated by the lower part of each of the plurality of open portions op, thereby an array substrate having a multi-domain structure in the pixel region P obtained. In the multi-domain structure, since liquid crystal molecules of the pixel region P are re-aligned along different directions, deterioration such as a color shift at specific azimuthal angles is prevented.

Although end parts of each of the plurality of open portions op are disposed inside the pixel electrode 155 of each pixel region P in FIG. 4, the end parts of each open portion op may be disposed to overlap the gate line 105 in another embodiment.

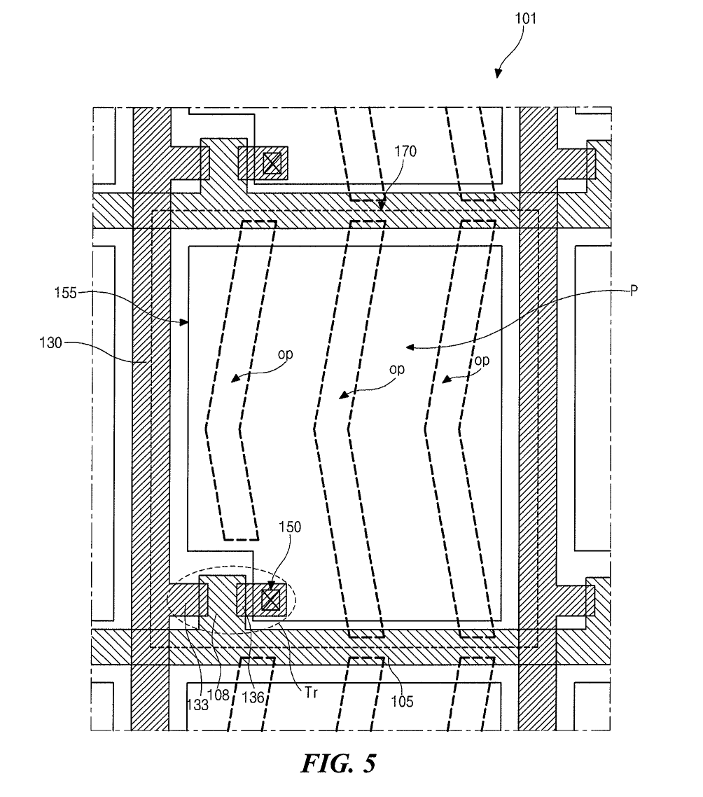

FIG. 5 is a plan view showing an array substrate for a fringe field switching mode liquid crystal display device according to a second embodiment of the present invention.

In FIG. 5, end parts of each of a plurality of open portions op are disposed outside a pixel electrode 155 of each pixel region P. For example, each of the plurality of open portions op may extend over the pixel electrode 155 such that the end parts of each of the plurality of open portions op overlap a gate line 105. Although the outermost open portion does not overlap the gate line 105 because the pixel electrode 155 is formed to expose a thin film transistor (TFT) Tr in FIG. 5, the end part of the outermost open portion op may overlap the gate line 105 in another embodiment where the TFT is disposed over the gate line 105 and the pixel electrode 155 is formed in the whole pixel region P.

In another embodiment, the plurality of open portions op in adjacent pixel regions P may be connected to each other so that each of the plurality of open portions op can constitute a zigzag shape in a whole display area.

An abnormal fringe field may be generated at the end parts of each of the plurality of open portions op, and an abnormal alignment of liquid crystal molecules may be caused by the abnormal fringe field. Accordingly, a disclination may occur at the end parts of each of the plurality of open portions op by the abnormal alignment of the liquid crystal molecules. Since the end parts of each of the plurality of open portions op are disposed outside the pixel electrode 155 and over the gate line 105 in the second embodiment, the fringe field is generated between side parts of each of the plurality of open portions op of the common electrode 170 and the pixel electrode 155 in each pixel region P, and the disclination due to the abnormal alignment of the liquid crystal molecules at the end parts of each of the plurality of open portions op is prevented. Alternatively, the disclination generated at the end parts of each of the plurality of open portions op is blocked by the gate line 105. As a result, the disclination is prevented or blocked, and aperture ratio and transmittance are improved.

In another embodiment where the plurality of open portions op in adjacent pixel regions P is connected to each other, since the end parts of each of the plurality of open portions op are not formed, the abnormal fringe field is not generated and the disclination is prevented. Accordingly, the disclination is minimized, and aperture ratio and transmittance are improved.

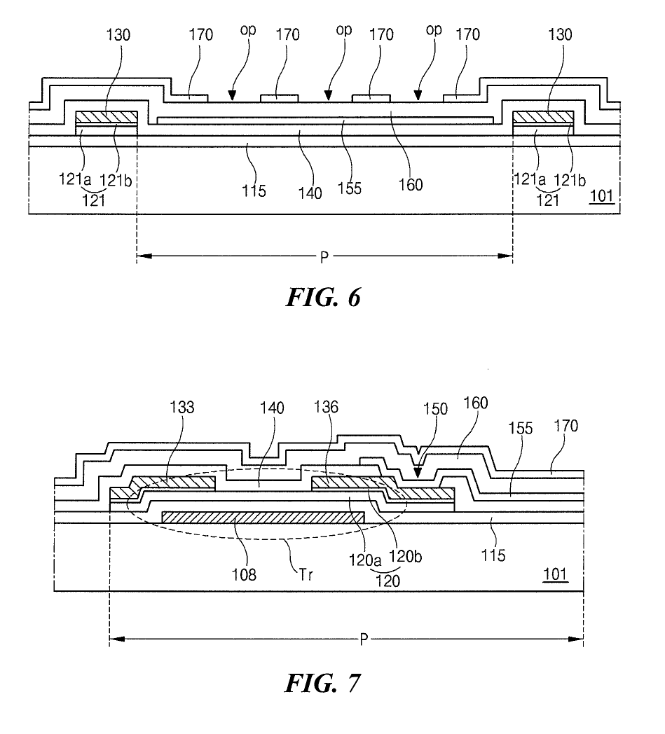

FIG. 6 is a cross-sectional view taken along a line VI-VI of FIG. 4, and FIG. 7 is a cross-sectional view taken along a line of FIG. 4.

In FIGS. 6 and 7, a gate line 105 (of FIG. 4) and a gate electrode 108 connected to the gate line 105 are formed on a substrate 101. The gate line 105 and the gate electrode 108 may include one of aluminum (Al), aluminum (Al) alloy, copper (Cu), copper (Cu) alloy, chromium (Cr), and molybdenum (Mo). A gate insulating layer 115 is formed on the gate line 105 and the gate electrode 108. The gate insulating layer 115 may include one of silicon nitride (SiNx) and silicon oxide (SiO₂).

A semiconductor layer 120 is formed on the gate insulating layer 115 over the gate electrode 108. The semiconductor layer 120 includes an active layer 120a of intrinsic amorphous silicon and an ohmic contact layer 120b of impurity-doped amorphous silicon. Source and drain electrodes 133 and 136 are formed on the semiconductor layer 120. The source and drain electrodes 133 and 136 are spaced apart from each other to expose the active layer 120a. The gate electrode 108, the gate insulating layer 115, the semiconductor layer 120, the source electrode 133 and the drain electrode 136 constitute a thin film transistor (TFT) Tr.

A data line 130 is formed over the gate insulating layer 115. The data line 130 crosses the gate line 105 to define a pixel region P. First and second semiconductor patterns 121a and 121b having the same material and the same layer as the active layer 120a and the ohmic contact layer 120b, respectively, may be formed between the gate insulating layer 115 and the data line 130. The first and second semiconductor patterns 121a and 121b may be omitted in another embodiment. The source electrode 133 of the TFT Tr is connected to the data line 130.

A first passivation layer 140 is formed on the TFT Tr and the data line 130. The first passivation layer 140 may include one of an inorganic insulating material such as silicon nitride (SiNx) and silicon oxide (Si₂) and an organic insulating material such as benzocyclobutene (BCB) and acrylic resin. The first passivation layer 140 includes a drain contact hole 150 exposing the drain electrode 136 of the TFT Tr. A pixel electrode 155 having a plate shape is formed on the first passivation layer in each pixel region P. The pixel electrode 155 may include a transparent conductive material such as indium-tin-oxide (ITO) and indium-zinc-oxide (IZO). The pixel electrode 155 is connected to the drain electrode 136 through the drain contact hole 150. In another embodiment, the first passivation layer 140 including the drain contact hole 150 may be omitted, and the pixel electrode 155 may directly contact the drain electrode 136.

A second passivation layer 160 is formed on the pixel electrode 155, and a common electrode 170 having a plate shape is formed on the second passivation layer 160. The second passivation layer 160 may include one of an inorganic insulating material such as silicon nitride (SiNx) and silicon oxide (SiO₂) and an organic insulating material such as benzocyclobutene (BCB) and acrylic resin. In addition, the common electrode 170 may include a transparent conductive material such as indium-tin-oxide (ITO) and indium-zinc-oxide (IZO). The common electrode 170 may be formed over an entire surface of the substrate 101. The common electrode 170 includes a plurality of open portions op. Each of the plurality of open portions op has a bar shape including a bent part. For example, the bent part may be disposed at a central portion of the pixel region and each of the plurality of open portions op may have a symmetric structure with respect to a virtual line connecting the bent parts and parallel to the gate line 105.

In the first embodiment as shown in FIG. 4, the plurality of open portions op may be disposed inside the pixel electrode 155 of each pixel region P. In the second embodiment as shown in FIG. 5, end parts of each of the plurality of open portions op may be disposed outside the pixel electrode 155 and may overlap the gate line 105. Further, in another embodiment, the plurality of open portions op of adjacent pixel regions P may be connected to each other.

Although the common electrode 170 includes three open portions op in the first and second embodiments of FIGS. 4 and 5, the number of the plurality of open portions op may vary within a range of 2 to 10 in another embodiment.

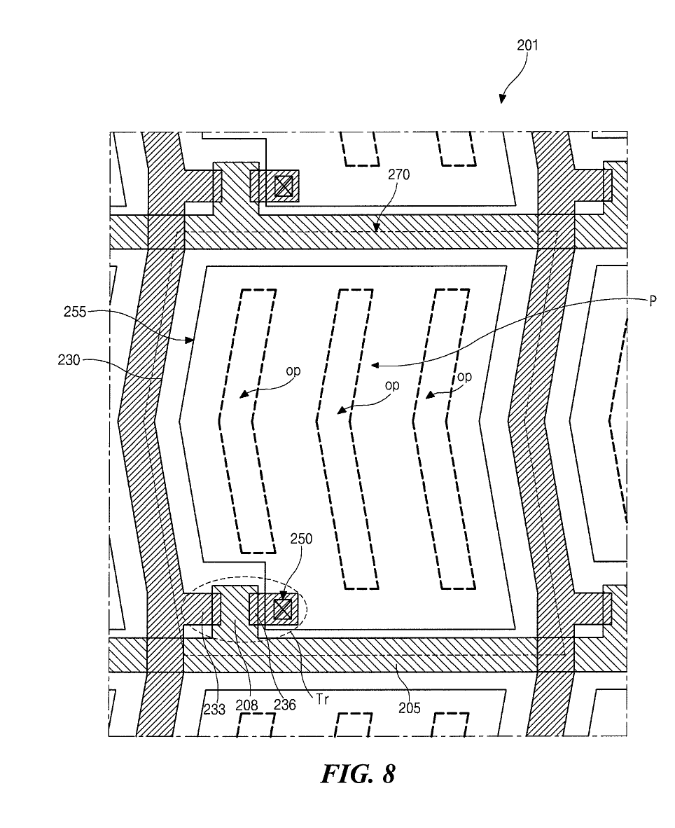

FIG. 8 is a plane view showing an array substrate for a fringe field switching mode liquid crystal display device according to a third embodiment of the present invention.

In FIG. 8, a plurality of gate lines 205 and a plurality of data lines 230 are formed over a substrate 201. The plurality of gate lines 205 cross the plurality of data lines 230 to define a plurality of pixel regions P. Each of the plurality of data lines 230 has a zigzag line shape having a bent part corresponding to a central portion of each pixel region P. A thin film transistor (TFT) Tr as a switching element connected to the corresponding gate line 205 and the corresponding data line 230 is formed in each pixel region P. The TFT Tr includes a gate electrode 208 connected to the gate line 205, a gate insulating layer (not shown) on the gate electrode 208, a semiconductor layer (not shown) on the gate insulating layer, a source electrode 233 connected to the data line 230 and a drain electrode 236 spaced apart from the source electrode 233. Although not shown in FIG. 8, the semiconductor layer includes an active layer of intrinsic amorphous silicon on the gate insulating layer and an ohmic contact layer of impurity-doped amorphous silicon on the active layer.

The source and drain electrodes 233 and 236 spaced apart from each other expose the active layer of the semiconductor layer, and the exposed portion of the active layer between the source and drain electrodes 233 and 236 is defined as a channel region. Although the TFT Tr of FIG. 8 has the channel region of a linear shape, a TFT may have a channel region of a “U” shape in another embodiment where one of source and drain electrodes has a “U” shape and the other of the source and drain electrodes has a bar shape. In addition, although the TFT Tr of FIG. 8 is disposed in the pixel region P, the semiconductor layer, the gate line 205 may function as a gate electrode the source electrode 233 and the drain electrode 236 may be disposed to overlap the gate line 205 in another embodiment.

A first passivation layer (not shown) is formed on the TFT Tr, and a pixel electrode 255 having a plate shape is formed on the first passivation layer in each pixel region P. The first passivation layer includes a drain contact hole 250 exposing the drain electrode 236 and the pixel electrode 255 is connected to the drain electrode 236 through the contact hole 250. The pixel electrode 255 may have a shape having a bent part corresponding to the data line 230. Further, a second passivation layer (not shown) is formed on the pixel electrode 255, and a common electrode 270 is formed on the second passivation layer. Although the common electrode 270 is formed over an entire surface of the substrate 201, a portion of the common electrode 270 corresponding to the pixel region P is shown in FIG. 8 for illustration. The common electrode 270 has a plate shape including a plurality of open portions op. The plurality of open portions op are disposed to correspond to the pixel electrode 255 in the pixel region P, and each of the plurality of open portions op has a bar shape including a bent part. For example, the bent part may be disposed at a central portion of the pixel region and each of the plurality of open portions op may have a symmetric structure with respect to a virtual line connecting the bent parts and parallel to the gate line 205.

Each of the plurality of open portions op includes upper and lower parts with respect to the bent part, and the upper and lower parts are disposed along different directions. As a result, an upper fringe field generated by the upper part of each of the plurality of open portions op has a different direction from a lower fringe field generated by the lower part of each of the plurality of open portions op, thereby an array substrate having a multi-domain structure in the pixel region P obtained. In the multi-domain structure, since liquid crystal molecules of the pixel region P are re-aligned along different directions, deterioration such as a color shift at specific azimuthal angles is prevented.

The shape of each data line 230 and the shape of the pixel electrode 255 correspond to the shape of each open portion op. For example, each of the data line 230 and the pixel electrode 255 may have a bent part corresponding to the bent part of each open portion op. As a result, the pixel region P defined by the gate line 205 and the data line 230 may have a concave hexagonal shape, and the pixel electrode 255 may also have a concave hexagonal shape.

Although end parts of each of the plurality of open portions op are disposed inside the pixel electrode 255 of each pixel region P in FIG. 8, the end parts of each open portion op may be disposed to overlap the gate line 205 in another embodiment.

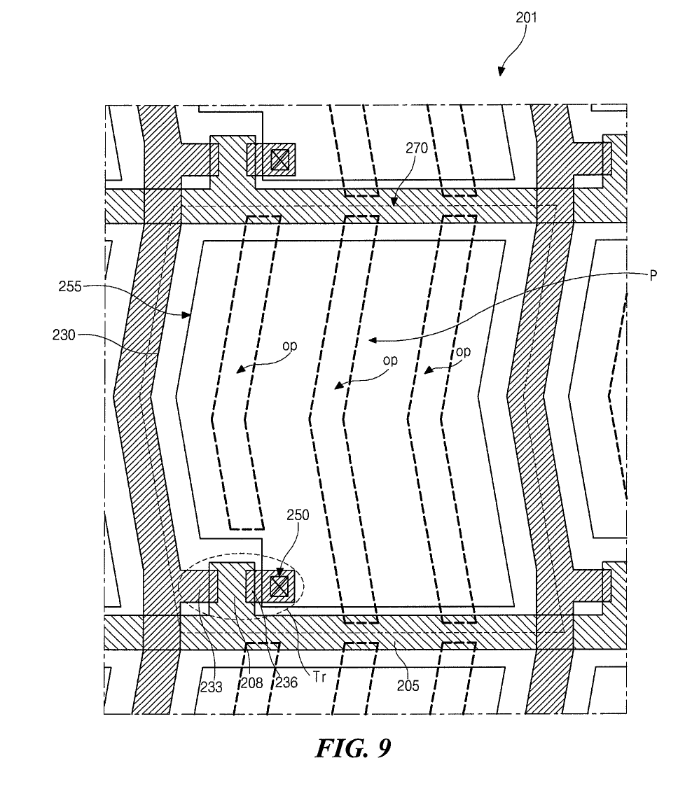

FIG. 9 is a plan view showing an array substrate for a fringe field switching mode liquid crystal display device according to a fourth embodiment of the present invention.

In FIG. 9, a plurality of gate lines 205 cross a plurality of data lines 230 to define a plurality of pixel regions P. Each of the plurality of data lines 230 has a zigzag shape having a bent part corresponding to a central portion of each pixel region P. In addition, end parts of each of a plurality of open portions op are disposed outside a pixel electrode 255 of each pixel region P. For example, each of the plurality of open portions op may extend over the pixel electrode 255 such that the end parts of each of the plurality of open portions op overlap a gate line 205. Although the outermost open portion does not overlap the gate line 205 because the pixel electrode 155 is formed to expose a thin film transistor (TFT) Tr in FIG. 9, the end part of the outermost open portion op may overlap the gate line 105 in another embodiment where the TFT Tr is disposed over the gate line 205 and the pixel electrode 255 is formed in the whole pixel region P.

Further, the shape of each data line 230 and the shape of the pixel electrode 255 correspond to the shape of each open portion op. For example, each of the data line 230 and the pixel electrode 255 may have a bent part corresponding to the bent part of each open portion op. As a result, the pixel region P defined by the gate line 205 and the data line 230 may have a concave hexagonal shape, and the pixel electrode 255 may also have a concave hexagonal shape.

In another embodiment, the plurality of open portions op in adjacent pixel regions P may be connected to each other so that each of the plurality of open portions op can constitute a zigzag shape in a whole display area.

An abnormal fringe field may be generated at the end parts of each of the plurality of open portions op, and an abnormal alignment of liquid crystal molecules may be caused by the abnormal fringe field. Accordingly, a disclination may occur at the end parts of each of the plurality of open portions op by the abnormal alignment of the liquid crystal molecules. Since the end parts of each of the plurality of open portions op are disposed outside the pixel electrode 255 and over the gate line 205 in the second embodiment, the fringe field is generated between side parts of each of the plurality of open portions op of the common electrode 270 and the pixel electrode 255 in each pixel region P, and the disclination due to the abnormal alignment of the liquid crystal molecules at the end parts of each of the plurality of open portions op is prevented. Alternatively, the disclination generated at the end parts of each of the plurality of open portions op is blocked by the gate line 205. As a result, the disclination is prevented or blocked, and aperture ratio and transmittance are improved.

In another embodiment where the plurality of open portions op in adjacent pixel regions P is connected to each other, since the end parts of each of the plurality of open portions op are not formed, the abnormal fringe field is not generated and the disclination is prevented. Accordingly, the disclination is minimized, and aperture ratio and transmittance are improved.

A method of fabricating an array substrate for a fringe field switching mode liquid crystal display device according to a first embodiment of the present invention of FIGS. 4, 6 and 7 will be illustrated hereinafter. Since each of methods of fabricating an array substrate according to second to fourth embodiments of the present invention is similar to the method of fabricating an array substrate according to the first embodiment of the present invention, the illustration for the methods of fabricating an array substrate according to the second to fourth embodiments will be omitted.

After a first metal layer (not shown) is formed on a substrate 101 by depositing a first metallic material such as aluminum (Al), aluminum (Al) alloy, copper (Cu), copper (Cu) alloy, chromium (Cr), and molybdenum (Mo), the first metal layer is patterned through a mask process including a coating step of a photoresist, an exposure step using a photo mask, a developing step for the exposed photoresist, an etching step for the first metal layer and a stripping step for the photoresist to form a gate line 105 and a gate electrode 108 connected to the gate line 105 on the substrate 101. Next, a gate insulating layer 115 is formed on the gate line 105 and the gate electrode 108 by depositing one of silicon nitride (SiNx) and silicon oxide (SiO₂).

Next, after an intrinsic amorphous silicon layer (not shown), an impurity-doped amorphous silicon layer (not shown) and a second metal layer (not shown) are sequentially formed on the gate insulating layer 115, a photoresist layer (not shown) is formed on the second metal layer. The second metal layer may include a second metallic material such as aluminum (Al), aluminum (Al) alloy, copper (Cu), copper (Cu) alloy, chromium (Cr), and molybdenum (Mo). The photoresist layer on the second metal layer is patterned through a photolithographic process using a photo mask having a blocking area, a half-transmissive area and a transmissive area to form first and second photoresist patterns having first and second thicknesses, respectively. The first thickness may be greater than the second thickness.

Next, the second metal layer, the impurity-doped amorphous silicon layer and the intrinsic amorphous silicon layer are removed using the first and second photoresist patterns as an etching mask to form a data line 130 and a source drain pattern (not shown). The data line 130 crosses the gate line 105 to define a pixel region P, and an ohmic contact pattern (not shown) and an active layer 120a are formed under the source drain pattern.

Next, after the second photoresist pattern is removed, the source drain pattern and the ohmic contact pattern exposed through the first photoresist pattern are sequentially removed to form source and drain electrodes 133 and 136 and an ohmic contact layer 120b under the source and drain electrodes 133 and 136. The gate electrode 108, the gate insulating layer 115, the semiconductor layer 120, the source electrode 133 and the drain electrode 136 constitute a thin film transistor (TFT) Tr.

Next, a first passivation layer 140 is formed on the TFT Tr and the data line 130 by depositing and patterning an inorganic insulating material such as silicon nitride (SiNx) and silicon oxide (SiO₂) or by coating and patterning an organic insulating material such as benzocyclobutene (BCB) and acrylic resin. The first passivation layer 140 includes a drain contact hole 150 exposing the drain electrode 136. In another embodiment, the first passivation layer 140 may be omitted.

Next, a pixel electrode 155 having a plate shape is formed on the first passivation layer 140 in each pixel region P by depositing and patterning a transparent conductive material such as indium-tin-oxide (ITO) and indium-zinc-oxide (IZO). The pixel electrode 155 is connected to the drain electrode 136 through the drain contact hole 150. In another embodiment, the first passivation layer 140 including the drain contact hole 150 may be omitted, and the pixel electrode 155 may directly contact the drain electrode 136.

Next, a second passivation layer 160 is formed on the pixel electrode 155 by depositing an inorganic insulating material such as silicon nitride (SiNx) and silicon oxide (SiO₂) or by coating an organic insulating material such as benzocyclobutene (BCB) and acrylic resin. Next, a common electrode 170 having a plate shape is formed on the second passivation layer 160 by depositing and patterning a transparent conductive material such as indium-tin-oxide (ITO) and indium-zinc-oxide (IZO). Next, a plurality of open portions op are formed in the common electrode 170. Each of the plurality of open portions op has a bar shape including a bent part. For example, the bent part may be disposed at a central portion of the pixel region P and each of the plurality of open portions op may have a symmetric structure with respect to a virtual line connecting the bent parts and parallel to the gate line 105.

In an array substrate for a fringe field switching mode LCD device according to the present invention, since each of a plurality of open portions of a common electrode has a bar shape having a bent part, a multi domain structure is obtained in a pixel region and a color shift is prevented. In addition, since end parts of each of the plurality of open portions are disposed outside a pixel electrode to overlap a gate line, a disclination is prevented and a display quality is improved.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An array substrate for a fringe field switching mode liquid crystal display device, comprising:
a substrate;
a gate line on the substrate;
a gate insulating layer on the gate line;
a data line on the gate insulating layer, the data line crossing the gate line to define a pixel region;
a thin film transistor connected to the gate line and the data line;
a pixel electrode in the pixel region, the pixel electrode having a plate shape and connected to the thin film transistor;
a first passivation layer on the pixel electrode; and
a common electrode including a plurality of open portions on the first passivation layer, each of the plurality of open portions having a bar shape including a bent part.

2. The array substrate according to claim 1, wherein bent part is disposed at a central portion of the pixel region and each of the plurality of open portions has a symmetric structure with respect to a virtual line connecting the bent part and parallel to the gate line.

3. The array substrate according to claim 2, wherein the data line has a straight line shape.

4. The array substrate according to claim 2, wherein the data line has a zigzag line shape.

5. The array substrate according to claim 4, wherein the bent part of each of the plurality of open portions corresponds to a bent portion of the zigzag line shape.

6. The array substrate according to claim 1, wherein end parts of each of the plurality of open portions are disposed outside the pixel electrode.

7. The array substrate according to claim 6, wherein the end parts of each of the plurality of open portions are disposed to overlap the gate line.

8. The array substrate according to claim 1, wherein the plurality of open portions in the adjacent pixel regions are connected to each other.

9. The array substrate according to claim 1, wherein the thin film transistor includes a gate electrode connected to the gate line, a gate insulating layer on the gate electrode, a semiconductor layer on the gate insulating layer over the gate electrode, a source electrode on the semiconductor layer and a drain electrode spaced apart from the source electrode.

10. The array substrate according to claim 9, further comprising a second passivation layer between the drain electrode and the pixel electrode, wherein the second passivation layer including a drain contact hole exposing the drain electrode and the pixel electrode is connected to the drain electrode through the drain contact hole.
